(19) United States
(12) Patent Application Publication
(10) Pub. No.: US 2006/0013231 A1
(43) Pub. Date: Jan. 19, 2006

(54) Consolidated ethernet optical network and apparatus

(75) Inventors: David L. Matthews, Algonquin, IL (US); Rodolfo Montelongo JR., Dallas, TX (US); Chin Yuan, San Ramon, CA (US); Orestis Manthoulis, Sausalito, CA (US); Laxman Sahasrabuddhe, San Ramon, CA (US)

Correspondence Address: TOLER & LARSON & ABEL L.L.P., 5000 PLAZA ON THE LAKE STE 265, AUSTIN, TX, 78746, US

(73) Assignee: SBC Knowledge Ventures, LP

(21) Appl. No.: 10/874,154

(22) Filed: Jun. 22, 2004

(51) Int. Cl. H04L 12/56

(52) U.S. Cl. 370/395.53

(57) ABSTRACT

A consolidated optical Ethernet network and apparatus are disclosed. In one form a network device includes an aggregation layer access interface operable to access an aggregation layer and a core layer access interface provided in combination with the aggregation layer access interface and operable to access a core layer. The device may be provided within a Multiprotocol Label Switching based Ethernet Optical Network (EON) as a network switch and may allow for efficient access to multiple layers of a network communicating information within the EON.

### BACKGROUND OF THE DISCLOSURE

A network may be characterized by several factors, such as who can use the network, the type of traffic the network carries, the medium carrying the traffic, the typical nature of the network's connections, and the transmission technology the network uses. For example, one network may be public and carry circuit-switched voice traffic while another may be private and carry packet-switched data traffic. Whatever the make-up, most networks facilitate the communication of information between at least two nodes, and as such act as communications networks.

At a physical level, a communication network may include a series of nodes interconnected by communication paths. Whether a network operates as a local area network (LAN), a metropolitan area networks (MAN), a wide are network (WAN) or some other network type, the act of designing the network becomes more difficult as the size and complexity of the network grows. When designing a given network, an operator or provider may decide where to physically locate various network nodes, may develop an interconnection strategy for those nodes, and may prepare a list of deployed and/or necessary networking components.

### BRIEF DESCRIPTION OF THE DRAWINGS

It will be appreciated that for- simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 illustrates a block diagram of a network that processes aggregate and core EON layers in accordance with the teachings of the present disclosure;

FIG. 2 presents a block diagram of a multiple-layer access node capable of accessing both aggregation and core layers according to one aspect of the present disclosure;

FIG. 3 presents a flow diagram illustrating operation of a multiple-layer access node within an EON in accordance with the teachings of the present disclosure; and

FIG. 4 illustrates a functional diagram of an EON in accordance with the teachings of the present disclosure.

### DETAILED DESCRIPTION OF THE DRAWINGS

Given the relative complexity of some communication networks, designers may invest substantial time and money to develop a feasible design for a given network. A feasible design may be one that satisfies design objectives like network coverage, network availability, and traffic demands, while considering that design limiters prefer defined limitations on equipment and/or interconnection topology.

In one form of the present disclosure, one or more core layer node and aggregator nodes are combined within the same node to reduce the number of physical nodes/locations required to employ a network. Such an embodiment displays several advantages over conventional networks that utilize separate nodes locations to access each layer. For example, the overall number of nodes or network elements required within a network may be reduced through the use of multiple-layer access nodes or elements and, as a result, the costs associated with cabling and electronics may be reduced. In other words, providing a multiple-layer node may assist in limiting the amount of hardware needed to deploy a desired network thereby reducing the overall cost of the network without sacrificing network performance.

Larger networks are often designed in layers. Each layer has its own roles and responsibilities. The goal of many network designers is to create a network that delivers high performance while maintaining a high degree of manageability. The following disclosure focuses on a layered design consisting of three layers, including a core layer, an aggregation layer, and an access layer.

From a high level, the core layer of a network may perform the backbone-like functions and may need to be both high speed and redundant. The aggregation layer may contain intermediate switches and routers, such as those used to route between subnets or VLANs. And, the access layer may be the point at which users actually plug into their local switch.

In practice, each layer in the model may have a primary responsibility and may be tasked with performing specific functions. As such, nodes of a given layer may need to have specific capabilities unique to that node's assigned layer. For example, the core layer may need to act as a high-speed switched backbone. A typical core layer node, therefore, does not perform routing functions. Core layer nodes may instead be expected to focus on switching traffic. Asking a core layer node to route traffic may reduce overall network performance, because each frame typically must be recreated as it passes through a router. In the core layer, the traffic tends to stay at OSI Layers 1 and 2 instead of having to be considered at Layer 3.

Unlike the core layer, the aggregation layer is the layer at which the routing functions are likely to be performed. The aggregation layer may also represent the point at which various traffic policies are implemented. This may be accomplished with the assistance of access lists maintained in network repositories.

As mentioned above, the access layer may act as the point at which end stations connect to the network. A typical interface into the layered network may involve plugging into a Layer 2 switch or hub. As such, one of the primary responsibilities at the access layer is management of network collision domains. The access layer may also be used to define additional network security policies and filtering.

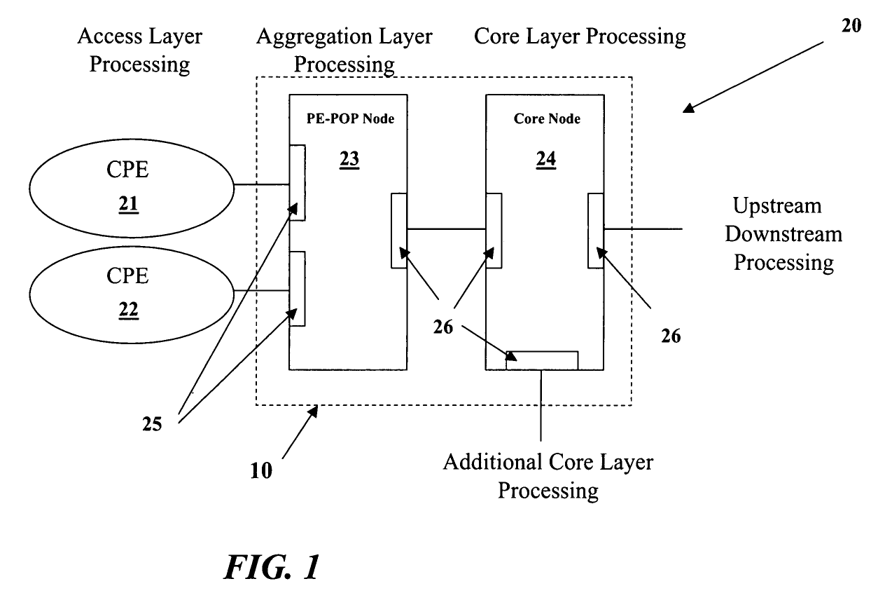

FIG. 1 illustrates a block diagram of a network capable of processing aggregation layer and core layer traffic at a single network node. The network described is a three layer EON. Though the following description focuses on EON design, the techniques of FIG. 1 and this disclosure may also be used to design other types of networks. As indicated above, networks may take several forms. For example, a network implementing teachings of the present disclosure may embody a three layer, high-speed, fiber-based, Ethernet over MPLS network. By practicing the teachings disclosed herein, an operator may elect to integrate Layer 2 switching capabilities and Layer 3 routing capabilities into a single network node. In some embodiments, a network designer may make use of Multiprotocol Label Switching (MPLS) techniques to facilitate this integration.

In an MPLS-based network, a network operator may enjoy greater flexibility when routing traffic around link failures, congestion, and bottlenecks. From a Quality of Service (QoS) perspective, MPLS-based networks may also allow network operators to better manage different kinds of data streams based on priority and/or service plans.

In operation, a packet entering an MPLS network may be given a “label” by a Label Edge Router (LER). The label may contain information based on routing table entry information, Internet Protocol (IP) header information, Layer 4 socket number information, differentiated service information, etc. As such, different packets may be given different Labeled Switch Paths (LSPs), which may “allow” network operators to make better decisions when routing traffic based on data-stream type.

An EON like network 20, as illustrated in FIG. 1 manages traffic flow using a layer-based access topology designed to expedite communication of information across a fiber network. Customer Premises Equipment (CPE) 21 and 22 may serve as nodes of an access layer at a customer site and may be communicatively coupled to Provider Edge—Point of Presence (PE-POP) node 23 via multiple port communication modules 25. PE-POP node 23 may act as a node in the aggregation layer, and may perform some routing functions for access layer traffic to and from CPE 21 and 22. Moreover, node 23 may also work to multiplex and demultiplex traffic associated with CPE 21 and 22. In some embodiments, node 23 may also be tasked with managing traffic from different types of media. For example, in operation, CPE 21 may be communicating with node 23 via an Ethernet link, and CPE 22 may be communicating with node 23 via a token ring link.

As shown, EON 20 also includes a core node 24 coupled to PE-POP 23 via communication ports 26, which may be operable to communicate information between nodes within EON 20. Core node 24 may serve core layer functions and may enable the high speed switching of traffic that is communicated between different aggregation layer nodes or PE-POP nodes.

PE-POP node 23 and core node 24 are typically provided as separate nodes having different physical locations within a network. As shown in FIG. 1, these nodes may be combined into a single node 10 capable of performing aggregation layer and core layer functions. As deployed, node 10 may have a housing component that at least partially defines an interior cavity. In preferred embodiments, one or more computing platforms capable of performing aggregation layer and core layer functions will be located within that interior cavity. Node 10 may also include one or more interface ports that allow for interconnection of node 10 with other nodes. In an EON network, these ports may facilitate coupling a fiber optic cable to node 10. The ports may also be labeled as “core layer port” or “aggregation layer port.” As such, traffic arriving via the Core layer port may be directed to a node 10 mechanism capable of performing core layer switching. Similarly, traffic arriving via an aggregation layer port may be directed to the same or different node 10 mechanism capable of performing aggregation layer functions, such as routing.

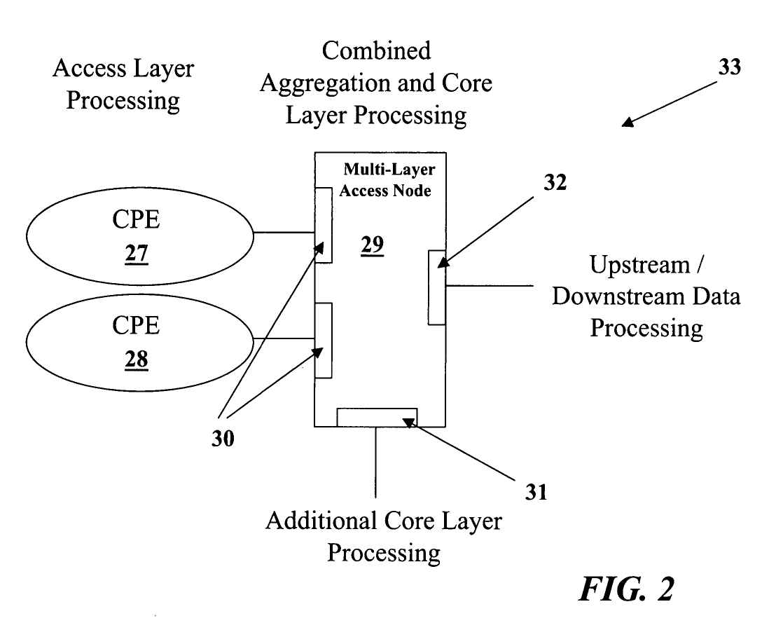

FIG. 2 illustrates one embodiment of a multiple-layer network node operable to perform both aggregation and core layer functions according to one aspect of the disclosure. Within EON 33, access layer sites 27 and 28 may allow users to interact with the network. Sites 27 and 28 are communicatively coupled to a multiple-layer network node 29 via communication ports 30. In practice, some aggregation layer and core layer functionality may be performed by multiple-layer node 29. For example, node 29 may be capable of combining network traffic for CPE 27 and 28 within a metro-based optical system. In addition, node 29 may be MPLS capable and operable to serve as the LER into the MPLS cloud.

In embodiments where multiple-layer node 29 also performs core layer switching, node 29 facilitates a reduction in the amount of network nodes. Depending upon the complexity of the network topology, data may be communicated upstream/downstream from multiple-layer node 29, to another core node, to a different aggregation node, to another multiple-layer node, to access layer nodes, etc.

As such, EON 33 presents several advantages over typical networks that may employ discrete boxes to perform aggregation layer and core layer processing. For example, the overall number of fibers needed within EON 33 may be reduced, the overall number of routers and switches may be reduced, the amount of common equipment may be reduced, the number of repeaters between each node or network element may be reduced, a reduction in the number of remote test heads may be provided, the amount of supporting test equipment may be reduced, and a reduction in network traffic may be realized. One or more of these advantages should enable a network operator to increase a network's efficiency, reduce network latency, and lower the amount of power needed to operate the network.

Depending upon implementation detail, one or more elements within EON 33 may be configured with encoded logic to assist with accessing and/or processing one or more layers of the OSI stack. Such encoded logic may be provided as computer-readable mediums having computer-readable instructions capable of instructing a network node to perform aggregation layer functions, to perform core layer functions, and/or to perform access layer functions, as needed. For example, multiple-layer node 29 may include encoded logic operable to allow for switching traffic at Layer 2 and routing traffic at Layer 3.

Several techniques may be used to provide for such a capability. Node 29 may employ a parallel processing schemas that make use of a multi-tasking processing engine. Node 29 may make use of discrete computing platforms—one dedicated to Layer 2 operations and another dedicated to Layer 3 operations. Node 29 may also elect to have both an internal core layer engine and an internal aggregation layer engine. Other techniques may also be utilized without departing from the teachings disclosed herein, and a choice of which technique to utilize may be determined by network design details, implementation details, and/or cost concerns.

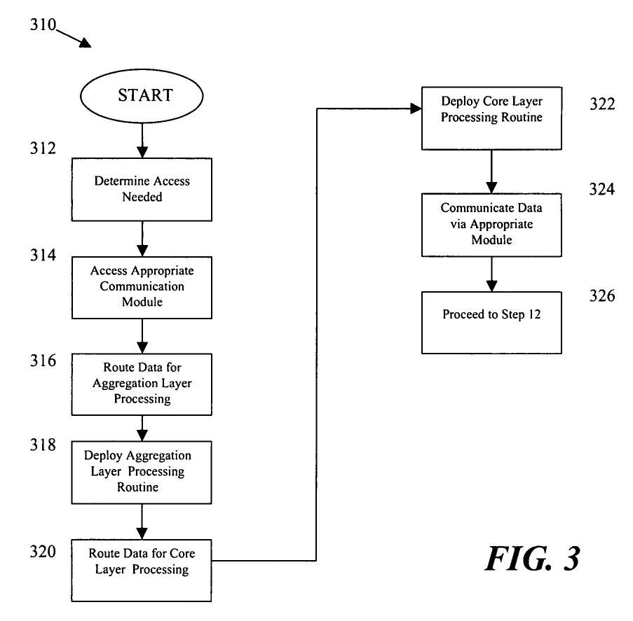

FIG. 3 presents a flow diagram illustrating operation of a multiple-layer node within an EON in accordance with the teachings of the present disclosure. The method may be employed by the one or more nodes of the networks disclosed herein or other network and/or nodes operable to employ the method of FIG. 3. The method begins generally when data is presented to a multiple-layer node operable to act on both core layer traffic and aggregation layer traffic. Capabilities to operate on other layers may also be incorporated.

At step 312, a type of processing needed is determined and access to an appropriate mechanism is provided at step 314. If aggregation layer capability is needed, traffic from one or more sources may be routed for aggregation layer treatment at step 316 and an aggregation layer processing routine may be deployed at step 318 to properly work on the traffic. For example, an originating node or address for the data traffic may be communicatively-coupled to the multiple-layer node via an aggregation layer port, and the multiple-layer node may recognize that traffic arriving via the port needs to be internally routed to a module capable of handling aggregation layer functionality.

Similarly, if some core layer capability is needed, traffic from one or more sources may be routed for core layer treatment at step 320 and a core layer processing routine may be deployed at step 322 to properly work on the traffic. As indicated above, the mechanism used to distinguish between traffic needing core layer processing and aggregation layer processing may be as simple as hard-wiring specific ports to specific modules. The mechanism may also involve actually looking at and/or sniffing information contained in the packet being received by the multiple-layer node. The node may look at information contained in a packet header, for example, and make a determination based on that information. The node may also use other technologies like VLAN tagging and/or MPLS to assist in making a proper determination.

However accomplished, traffic received at step 312 may be properly processed and communicated to the next node in the network chain at step 324. The method may then proceed to step 26 where the method is repeated based on access and/or required processing. As such, a single node or network element may be used to combine processing of both core layers and aggregation layers thereby increasing the efficiency of an EON system. It should be understood that FIG. 3 illustrates one example of a method that may be used to enable multiple-layer processing in a layered network. The method of FIG. 3 may also be applied to other types of networks and/or devices. Moreover, an entity making use of the method may add steps, delete steps, re-order steps, loop steps, and/or modify the method without departing from the teachings.

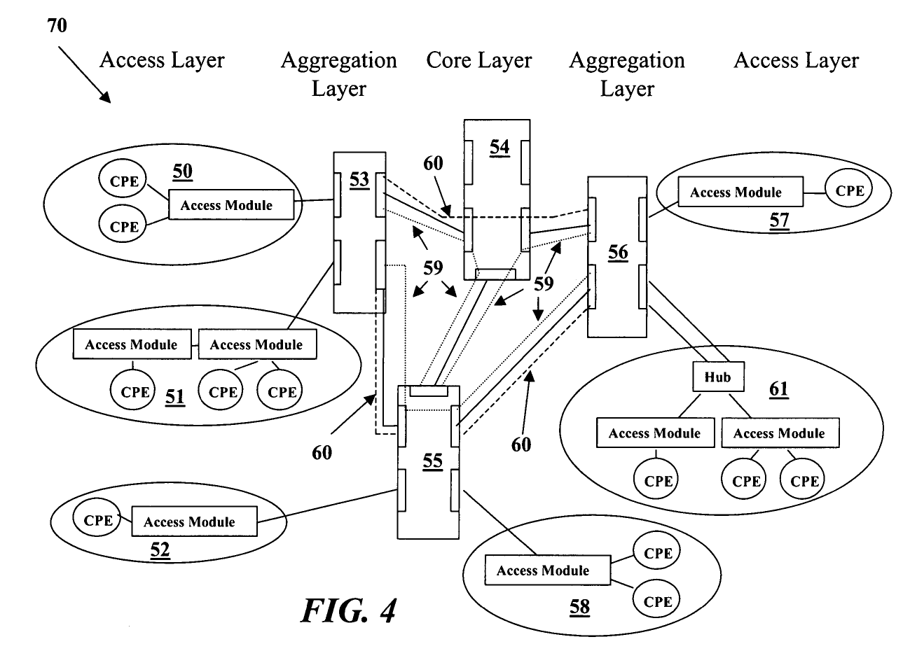

FIG. 4 illustrates a functional diagram of an EON in accordance with the teachings of the present disclosure. EON 70 illustrates one embodiment for employing a multiple-layer node capable of aggregation and core layer processing within a communication network. Information or data may be communicated between various access points having one or more types of configurations or topologies. For example, dual network access points 50 and 58 may include access modules that provide access to an access layer using two CPE modules. Single network access points 52 and 57 may allow for a single CPE to access an access layer. EON 70 further includes a multiple access module at site 51 that may be configured to allow for communication with multiple CPE access points using a series-based network topology. A hub access site 61 may also provided within EON 70 and may include a parallel access hub terminal coupled to multiple access modules and associated CPEs.

EON 70 illustrates specific layers for handling network traffic based on access privileges and functionality that is specific to each node within EON 70. For example, each CPE element may communicate information to and from an access layer node. Aggregation processing modules 53 and 56 may be configured to manage aggregation layer functions, and core layer processing module 54 may be configured to manage core layer functions. Each node or element may be aligned with a specific layer to enable efficient management of network traffic within EON 70. However, multiple-layer node 55 may straddle the aggregation layer and the core layer paradigms, and allow for aggregation layer and core layer processing of network traffic.

In one embodiment, aggregation layer processing modules 53 and 56, core layer processing module 54, and combined processing module 55 may be included within a single device configured to perform the functionality of two or more network layers. For example, a network designer may elect to utilize a Cisco 7609 IP/MPLS switch to perform multiple-layer functionalities.

Within network 70, the communication of network traffic may be provided by fiber optic interconnects, fibers, etc.—facilitating metropolitan Ethernet services. As such, additional components, such as repeaters, may be utilized based on network complexity, size, cable distance, db loss, etc. Redundancy of communication mediums may also be provided via EoMPLS-VC 60 and backup VC 59 connections.

During operation, network traffic may be communicated from CPE sites 50 and 51 using aggregation node 53. Similarly, network traffic for CPE sites 57 and 61 may be consolidated using aggregation node 56. Core node 54 may support aggregation nodes 53 and 56 by enabling switched communication with other core layer nodes. Network traffic for each of aggregation nodes 53 and 56 may further be routed to multiple-layer node 55, which may be operable to access both the aggregation layer and the core layer. As shown, multiple-layer node 55 is coupled to CPE sites 52 and 58, and provides efficient processing of data by reducing the number of nodes required to access both aggregation and core layers. In this manner, processing of data associated with CPE sites 52 and 58 may be reduced thereby limiting the level of network complexity and overall network traffic within EON 70.

Many of the above techniques may be provided by a computing device executing one or more software applications or engines. The software may be executing on a single system, node, more than one, etc. It will be apparent to those skilled in the art that the disclosed embodiments may be modified in numerous ways and may assume many embodiments other than the particular forms specifically set out and described herein.

Accordingly, the above-disclosed subject matter is to be considered illustrative, and not restrictive, and the appended claims are intended to cover all such modifications, enhancements, and other embodiments that fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. An optical network comprising:
a network node operable to access an aggregation layer and a core layer;
a first output of the network node operable to output core layer traffic to a core layer node; and
a second output of the network node operable to output aggregation layer traffic to an aggregation layer node.

2. The network of claim 1, further comprising an Access layer node communicatively coupled to the network node and operable to form at least a portion of a link communicatively coupling a local area network computing device with the core layer node.

3. The network of claim 1, further comprising the core layer node, which is operable to perform core layer switching.

4. The network of claim 3, further comprising the aggregation node, which is operable to perform aggregation layer routing.

5. The network of claim 1, wherein the network node comprises a core layer module communicatively coupled to the first output, the core layer module operable to operable to perform core layer switching and an aggregation layer module communicatively coupled to the second output, the aggregation layer module operable to perform aggregation layer routing.

6. The network of claim 5, wherein the network node further comprises a housing component at least partially defining an interior cavity, further wherein the aggregation layer module and the core layer module are at least partially located within the interior cavity.

7. The network of claim 1, wherein the network node comprises at least one 16-port module.

8. The network of claim 1, wherein the network node comprises at least one 4-port module.

9. The network of claim 6, wherein the network node comprises at least one 16-port module.

10. The network of claim 1, wherein the network node comprises an access layer interface operable to be directly coupled to an access layer node.

11. The network of claim 10, wherein the network node comprises a dedicated aggregation layer interface and a dedicated core layer interface.

12. The network of claim 1 further comprising an Ethernet Optical Network.

13. The network of claim 12, further comprising a Multiprotocol Label Switching (MPLS) based network.

14. The network of claim 13 further comprising a label-switching based network.

15. The network of claim 1 comprising:
a PE-POP node coupled to the network node and operable to access an aggregation layer; and
a core node coupled to the network node and the PE-POP node and operable to access a core layer.

16. A method of processing information within a network comprising:
accessing an aggregation layer using a network node;
accessing a core layer using the network node;
switching at least a portion of core layer traffic using the network node; and
routing at least a portion of aggregation layer traffic using the network node.

17. The method of claim 16 further comprising:
determining a network layer for incoming traffic; and
selecting a communication port in response to determining the network layer.

18. The method of claim 17 wherein the network layer comprises the aggregation layer.

19. The method of claim 17 wherein the network layer comprises the core layer.

20. The method of claim 17 further comprising accessing a PE-POP node via the communication port.

21. The method of claim 17 further comprising accessing a Core Layer node via the communication port.

22. The method of claim 17 further comprising accessing an Access Layer node via the communication port.

23. The method of claim 16 further comprising communicating information between a PE-POP node and the network node via the communication port.

24. The method of claim 16 further comprising communicating information between a core node and the network node via the communication port.

25. A computer-readable medium having computer-readable data operable to:
access an aggregation layer using a network node;
access a core layer using the network node;
perform a core layer switching function using the network node; and
perform an aggregation layer routing function using the network node.

26. The computer-readable medium of claim 25 further comprising data operable to:
determine a network layer for received information; and
initiate performance of a core layer switching function in response to determining the network layer.

27. The computer-readable medium of claim 26 further comprising data operable to access the aggregation layer.

28. The computer-readable medium of claim 26 further comprising data operable to access the core layer.

29. The computer-readable medium of claim 26 further comprising data operable to access a PE-POP node via the communication port.

30. The computer-readable medium of claim 26 further comprising data operable to access a core layer node via the communication port.

31. The computer-readable medium of claim 26 further comprising data operable to access an access layer node via the communication port.

32. The computer-readable medium of claim 25 further comprising data operable to communicate information between a PE-POP node and the network node via the communication port.

33. The computer-readable medium of claim 25 further comprising data operable to communicate information between a core node and the network node via the communication port.

34. A network device comprising:
an aggregation layer access interface operable to access an aggregation layer; and
a core layer access interface provided in combination with the aggregation layer access interface and operable to access a core layer.

35. The device of claim 34, further comprising at least one communication port operable to communicate with a PE-POP node.

36. The device of claim 34, further comprising at least one communication port operable to communicate with a core node.

37. The apparatus of claim 34 further comprising at least one communication port operable to communicate with an access layer node.

38. The device of claim 37 wherein the access layer node includes at least one CPE node.

39. The device of claim 34, wherein the network comprises a MPLS-based EON.

40. The device of claim 34, further comprising:
a first communication communicatively coupled to a core node; and
a second communication port communicatively coupled to an aggregation layer node.

41. The device of claim 34, further comprising multiple communication ports operable to communicate with multiple PE-POP nodes.

42. The device of claim 34, further comprising a network switch.

43. The device of claim 34, further comprising at least one 4-port communication module operable to communicate with at least one of a PE-POP node or a core node.

44. The device of claim 34, further comprising at least one 16-Port communication module operable to communicate with a CPE node.

45. The device of claim 40, wherein a 16-port Gigabyte Ethernet (GigE) card comprises the second communication port.

46. The device of claim 34, wherein a 4-port GigE MPLS card comprises the core layer access interface and a 16-port GigE card comprises the aggregation layer access interface.

47. The device of claim 34, wherein a single card comprises the core layer access interface and the aggregation layer access interface.
